(19) United States
(12) Patent Application Publication
(10) Pub. No.: US 2026/0264691 A1
(43) Pub. Date: Sep. 10, 2026

(54) CONTROL APPARATUS FOR VEHICLE

(71) Applicant: TOYOTA JIDOSHA KABUSHIKI KAISHA, Toyota-shi (JP)

(72) Inventors: Shinji HATTORI, Toyota-shi (JP); Takahiro KONDO, Toyota-shi (JP); Shoichi FUKUCHI, Okazaki-shi (JP)

(73) Assignee: TOYOTA JIDOSHA KABUSHIKI KAISHA, Toyota-shi (JP)

(21) Appl. No.: 19/546,777

(22) Filed: Feb. 23, 2026

(30) Foreign Application Priority Data
Mar. 4, 2025 (JP) 2025-034063

(51) Int. Cl. B60W 30/20

(52) U.S. Cl. CPC B60W 30/20; B60W 2030/206; B60W 2510/083

(57) ABSTRACT

A control apparatus for a vehicle including a drive wheel, a power source that includes an electric motor, and a gear-type power transmission device that is provided in a power transmission path between the power source and the drive wheel. The control apparatus is configured to execute a damping control for causing the electric motor to output a damping torque for suppressing vibrations in the vehicle. The control apparatus is configured, when switching the vehicle from a non-driven state to a driven state, to execute a backlash elimination control within a predetermined backlash elimination period, for stopping or slowly changing a torque of the power source. The control apparatus is configured to stop execution of the damping control at least during execution of the backlash elimination control.

This application claims priority from Japanese Patent Application No. 2025-034063 filed on Mar. 4, 2025, the disclosure of which is herein incorporated by reference in its entirety.

### FIELD OF THE INVENTION

The present invention relates to a control apparatus for a vehicle that includes a drive wheel, a power source that includes an electric motor, and a gear-type power transmission device that is provided in a power transmission path between the power source and the drive wheel.

### BACKGROUND OF THE INVENTION

There is known a control apparatus for a vehicle that includes a drive wheel, a power source that includes an electric motor, and a gear-type power transmission device that is provided in a power transmission path between the power source and the drive wheel. For example, a vehicle control apparatus described in Patent Document 1 is such an apparatus. Patent Document 1 discloses a technique for executing a control (hereinafter referred to as backlash elimination control) that provides a time period for alleviating an increase of a torque of the electric motor in order to suppress rattling shock that occurs when gear backlash in the gear-type power transmission device is eliminated when the vehicle transitions from a deceleration state to an acceleration state, for example, when the electric motor (power source) transitions from a regenerative operation to a power running. Further, Patent Document 2 discloses a technique for executing a damping control that causes the electric motor to output a damping torque for suppressing vibrations in the vehicle.

### PRIOR ART DOCUMENT

### Patent Documents

[Patent Document 1] JP 2023-61270 A.

[Patent Document 2] JP 2023-103875 A.

### SUMMARY OF THE INVENTION

By the way, when the above-described backlash elimination control and damping control are used together, an operation of the damping control interferes with an operation of the backlash elimination control, so that the torque for backlash elimination is deviated from the target value, thereby changing a time required to eliminate the backlash. As a result, the backlash elimination is unlikely to be completed at an intended timing, so that the rattling shock is likely to occur when crossing the backlash.

The present invention was made against the background of the above circumstances, and its purpose is to provide a control apparatus for a vehicle, wherein the control apparatus is capable of suppressing occurrence of rattling shock where a damping control in addition to a backlash elimination control is executed.

According to the present invention, there is provided a control apparatus for a vehicle including (i) a drive wheel, (ii) a power source that includes an electric motor, and (iii) a gear-type power transmission device that is provided in a power transmission path between the power source and the drive wheel. The control apparatus is configured to execute a damping control for causing the electric motor to output a damping torque for suppressing vibrations in the vehicle. The control apparatus is configured, when switching the vehicle from a non-driven state to a driven state, to execute a backlash elimination control within a predetermined backlash elimination period, for stopping or slowly changing a torque of the power source. The control apparatus is configured to stop execution of the damping control at least during execution of the backlash elimination control.

In the control apparatus according to the present invention, the execution of the damping control is stopped at least while the backlash elimination control is being executed. As a result, the damping control is stopped while the backlash elimination control is being executed, so that operational interference by the damping control is suppressed and backlash elimination is carried out at a timing targeted by the backlash elimination control. Therefore, even where the backlash elimination control and the damping control are used in combination, occurrence of rattling shock is suppressed.

### BRIEF DESCRIPTION OF THE DRAWINGS

FIG. 1 is a view showing a vehicle to which the present invention is applied.

FIG. 2 is a timing chart showing an example of a control operation of an electronic control apparatus when switching from a non-driven state to a driven state in the vehicle of FIG. 1.

FIG. 3 is a timing chart showing an example of the control operation of the electronic control apparatus when a backlash elimination period is detected by using a different method.

FIG. 4 is a flowchart explaining main control operations of the electronic control apparatus, which are shown in the time chart of FIG. 2 or FIG. 3.

FIG. 5, which corresponds to FIG. 2, is a timing chart showing the control operation of the electronic control apparatus in another embodiment of the present invention.

FIG. 6, which corresponds to FIG. 4, is a flowchart explaining the main control operations of the electronic control apparatus, which are shown in the time chart of FIG. 5.

### DETAILED DESCRIPTION OF PREFERRED EMBODIMENTS

Hereinafter, preferred embodiments of the present invention will be described in detail with reference to the drawings. It is noted that, unless otherwise specified, drawings in each embodiment have been appropriately simplified or modified, and dimensional ratios and shapes of each part are not necessarily accurately depicted.

### First Embodiment

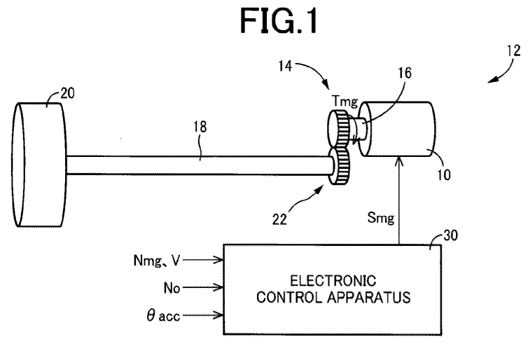

FIG. 1 is a view that illustrates a construction of a vehicle 12 equipped with an electric motor 10 as a power source.

The vehicle 12 is equipped with a gear-type power transmission device 14. The power transmission device 14 is a device that transmits a power from the electric motor 10 to the drive wheels 20, and includes an input shaft 16 to which the power from the electric motor 10 is inputted and a speed reducer 22 that reduces a speed of a rotation while transmitting the rotation from the input shaft 16 to the drive wheels 20 via an output shaft 18.

The power transmission device 14 includes a transmission and a differential gear device, and the speed reducer 22 is the transmission or differential gear device. The output shaft 18 is a power transmission shaft within the transmission or between the transmission and differential gear device, or a drive shaft between the differential gear device and drive wheels 20. The transmission and differential gear device have backlash resulting from gap (play) between tooth surfaces of meshing gears or spline engagement structure. When power transmission is resumed after being interrupted between a non-driven state and a driven state, the backlash is eliminated whereby and collision between the tooth surfaces is caused, resulting in a so-called rattling shock S.

The vehicle 12 is equipped with an electronic control apparatus 30, which is constituted by a so-called microcomputer that functions as a control apparatus for the vehicle 12.

The electronic control apparatus 30 is supplied with a signal representing an MG rotational speed Nmg, which is a rotational speed of the electric motor 10, from a rotational speed sensor provided in the electric motor 10, and a signal representing an output rotational speed No, which is a rotational speed of the output shaft 18, from a rotational speed sensor provided in the output shaft 18. The MG rotational speed Nmg corresponds to a running speed V of the vehicle 12. Further, the electronic control apparatus 30 is supplied with a signal representing an acceleration opening degree θacc from an acceleration opening degree sensor. The electronic control apparatus 30 also outputs an MG control signal Smg, which controls a drive of the electric motor 10, to an inverter (not shown) provided in the electric motor 10. The inverter controls the electric motor 10 by using the MG control signal Smg, thereby controlling the MG torque Tmg, which is an output torque of the electric motor 10. The MG rotational speed Nmg corresponds to “rotational speed of an output shaft of the power source” in the present”. The MG torque Tmg corresponds to “torque of the power source” in the present invention.

The electronic control apparatus 30 calculates an amount of drive demand from a driver for the vehicle 12, for example, by applying the acceleration opening degree θacc and the vehicle running speed V to a predetermined drive demand map, and controls the MG torque Tmg based on the calculated amount of the drive demand, thereby controlling a drive force of the vehicle 12.

The electronic control apparatus 30 executes a damping control VC, which causes the electric motor 10 to output a damping torque Tvc for suppressing torsional vibrations in a drivetrain (including the power transmission device 14 and output shaft 18) that causes vibrations in the vehicle 12. Specifically, the electronic control apparatus 30 detects fluctuations in a rotational speed difference between the MG rotational speed Nmg, which is the rotational speed of the electric motor 10 (power source), and the output rotational speed No, which is the rotational speed of the output shaft 18, on the same axis, and executes a feedback control (vibration suppression feedback control) to output a damping torque Tvc such that the fluctuations in the rotational speed difference (torsional vibrations) are suppressed. The damping torque Tvc is added to the original MG torque Tmg and then outputted.

In addition, when switching the vehicle 12 from a non-driven state to a driven state, the electronic control apparatus 30 executes a backlash elimination control GC for stopping or gradually changing an increase of the MG torque Tmg for a predetermined backlash elimination period GT, thereby suppressing occurrence of the rattling shock S.

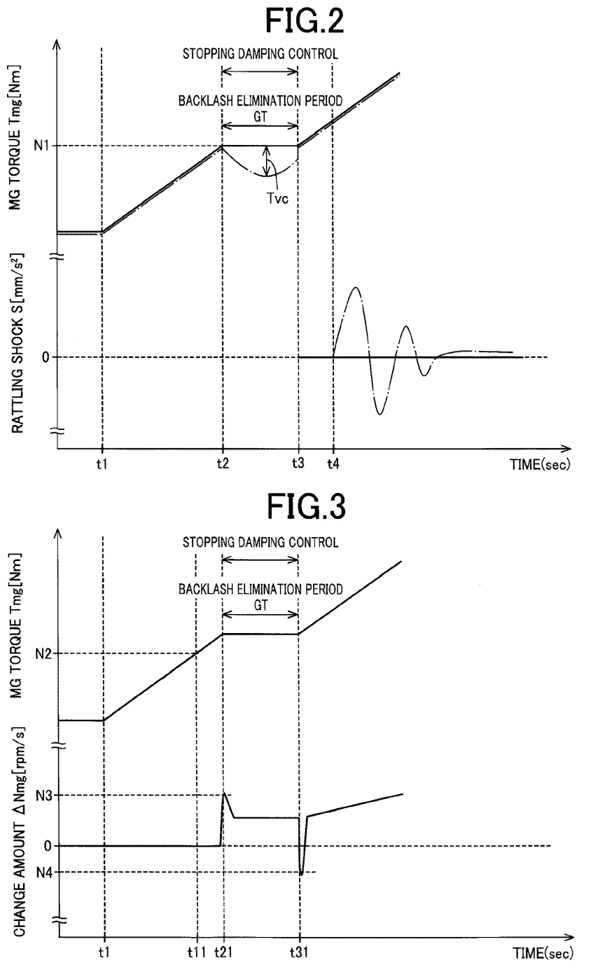

FIG. 2 is a time chart showing an example of the control operation of the electronic control apparatus 30 when the vehicle 12 is switched from the non-driven state to the driven state. The upper part shows transition of the MG torque Tmg, and the lower part shows transition of the occurrence of the rattling shock S. Further, in FIG. 2, solid line shows the present embodiment in which execution of the damping control VC is stopped while the backlash elimination control GC is being executed, and dashed line shows a conventional example in which execution of the damping control VC is not stopped while the backlash elimination control GC is being executed.

First, the operation indicated by the solid line (in the present embodiment) in FIG. 2 will be explained. At time point t1, the driver's request for acceleration (an increase of the acceleration opening degree θacc) initiates a switch from the non-driven state to the driven state, and the MG torque Tmg is increased.

Next, at time point t2 at which the MG torque Tmg becomes not lower than a predetermined first value N1, the backlash elimination period GT begins, and the backlash elimination control GC is initiated. In the backlash elimination control GC, a backlash elimination torque Tg is outputted to stop or slowly change the increase of the MG torque Tmg during the backlash elimination period GT. In FIG. 2, the backlash elimination period GT is set to a predetermined period T1 starting from the time point t2 at which the MG torque Tmg becomes not lower than the predetermined first value N1, and the backlash elimination torque Tg is maintained at its predetermined first value (Tg =N1) during the backlash elimination period GT (=T1). Then, at time point t3 when the backlash elimination period GT ends, the backlash elimination control GC ends, and the MG torque Tmg is increased again from the time point t3.

The predetermined first value N1 is a suitable value that can be determined to initiate backlash elimination when the MG torque Tmg is increased to the predetermined first value N1, and is set by determining it in advance through design or experimentation. Similarly to the predetermined first value N1, the predetermined period T1 is a suitable value that can be determined to complete the backlash elimination after lapse of the predetermined period T1, and is set by determining it in advance through design or experimentation.

The dashed line in FIG. 2 shows the operation of the conventional example in which the damping control VC is not stopped while the backlash elimination control GC is being executed. In the conventional example, the damping control VC is executed even while the backlash elimination control GC is being executed, i.e., during the backlash elimination period GT, so that the MG torque Tmg during the backlash elimination period GT is a sum of the backlash elimination torque Tg (predetermined first value N1 in FIG. 2) and the damping torque Tvc. As shown in FIG. 2, during the backlash elimination period GT, a negative torque is outputted as the damping torque Tvc through a feedback control, so that the MG torque Tmg is reduced by the damping torque Tvc. As a result, the backlash elimination torque Tg for the backlash elimination is deviated from the target value (=N1) to a smaller value, whereby the time to eliminate the backlash is changed, so that the backlash elimination is not completed at the timing that should have been within the backlash elimination period GT (by time point t3). If the backlash elimination is completed at time point t4 at which the MG torque Tmg starts to be increases again, the rattling shock S shown in bottom of FIG. 2 will occur.

The electronic control apparatus 30 stops execution of the damping control VC during execution of the backlash elimination control GC such that the operation is realized as shown by the solid line in FIG. 2. As a result, the damping control VC is stopped while the backlash elimination control GC is being executed, preventing operational interference by the damping control VC and enabling the backlash elimination to be completed at the timing targeted by the backlash elimination control GC. Therefore, even where the backlash elimination control GC and the damping control VC are used together, the occurrence of the rattling shock S is suppressed.

Preferably, the backlash elimination torque Tg in the backlash elimination period GT may be controlled not only to stop increase (maintain Tg=N1) as shown in FIG. 2, but also to be changed gradually (increased gradually). In this case, the set values for the time duration of the backlash elimination period GT and a rate of the increase of the backlash elimination torque Tg are set to suitable values determined in advance by design or experiment.

Preferably, the backlash elimination period GT may be such that the occurrence timing (time points) of the backlash elimination start and the backlash elimination completion are directly detected. When the vehicle 12 is switched from the non-driven state to the driven state, the MG rotational speed Nmg is increased upon the backlash elimination start when the meshed tooth surfaces separate, and is reduced upon the backlash elimination completion when the tooth surfaces come into contact and mesh. Therefore, by monitoring an amount ΔNmg of change per unit time Δt of the MG rotational speed Nmg, the occurrence timing (time points) of the backlash elimination start and the backlash elimination completion are detected.

FIG. 3 is a timing chart that explains an example of control operation in which the occurrence timing of the backlash elimination start and the occurrence timing of the backlash elimination completion are directly detected. The upper part shows the transition of the MG torque Tmg, and the lower part shows the transition of the change amount ΔNmg.

First, as in FIG. 2, at time point t1, switching from the non-driven state to the driven state begins, and the MG torque Tmg is increased. Next, at time point t11, when the MG torque Tmg becomes not lower than a predetermined second value N2, monitoring of the change amount ΔNmg begins. At time point t21, when the change amount ΔNmg becomes not smaller than a predetermined third value N3 (ΔNmg≥N3), the start of the backlash elimination is detected and the backlash elimination period GT begins (the backlash elimination control GC begins), whereby the backlash elimination torque Tg (MG torque Tmg increase is stopped) is outputted. At time point t31, when the change amount ΔNmg becomes not larger than the predetermined fourth value N4 (ΔNmg≤N4), the completion of the backlash elimination is detected and the backlash elimination period GT ends (backlash elimination control GC ends), whereby the MG torque Tmg is increased again from time point t31.

In this way, the backlash elimination period GT may be the period from the time point at which the MG torque Tmg become not lower than the predetermined second value N2 and the change amount ΔNmg of the MG rotational speed Nmg per unit time Δt becomes not smaller than the predetermined third value N3 (ΔNmg≥N3), to the time point at which the change amount ΔNmg becomes not larger than the predetermined fourth value N4 (ΔNmg≤N4). This allows the start of the backlash elimination and the completion of the backlash elimination to be detected directly, so that, even where the backlash elimination control GC and the damping control VC are used in combination, the occurrence of the rattling shock is suppressed with high accuracy. The predetermined second value N2 and the predetermined third value N3 are set to suitable values that enable the start of the backlash elimination to be detected, and the predetermined fourth value N4 is set to a suitable value that enables the completion of backlash elimination to be detected, which are determined in advance by design or experiment. Further, the unit time Δt is set to a suitable value so as to have the resolution to detect the start of the backlash elimination and the completion of the backlash elimination from the change amount ΔNmg.

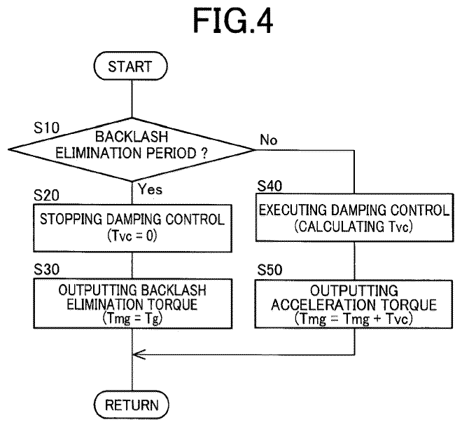

FIG. 4 is a flowchart explaining main control operations of the electronic control apparatus 30, which are shown in the time chart of FIG. 2 or FIG. 3. A control routine shown in the flow chart of FIG. 4 is initiated, for example, when the MG torque Tmg starts to be increased (at time point t1 in FIG. 2 or FIG. 3), and is executed repeatedly.

Each step of the control routine corresponds to function of the electronic control apparatus 30. As shown in FIG. 4, the control routine is initiated with step S10 that is implemented to determine whether or not it is the backlash elimination period GT, i.e., whether or not it is the period in which backlash elimination control GC is to be executed. When an affirmative determination is made at step S10, the execution of the damping control VC is stopped at step S20 (damping torque Tvc=0), and then at step S30, the backlash elimination torque Tg is outputted as the MG torque Tmg, and this routine is returned.

When a negative determination is made at step S10, namely, when the backlash elimination period GT is not started yet, the control flow goes to step S40 at which the damping control VC is executed (the damping torque Tvc is calculated). Then, at step S50, the damping torque Tvc is added to the original MG torque Tmg for accelerating the vehicle 12 (Tmg=Tmg+Tvc), and the MG torque Tmg is outputted, and this routine is returned.

As described above, in the electronic control apparatus (control apparatus) 30 for the vehicle 12 according to the present embodiment, the execution of the damping control VC is stopped while the backlash elimination control GC is being executed. As a result, since the damping control VC is stopped while the backlash elimination control GC is being executed, the operational interference by the damping control VC is suppressed and the backlash elimination is completed at the timing targeted by the backlash elimination control GC. Therefore, even where the backlash elimination control GC and the damping control VC are used in combination, the occurrence of the rattling shock S is suppressed.

Further, in the electronic control apparatus 30 according to the present embodiment, the backlash elimination period GT is a predetermined period T1 that begins when the MG torque Tmg becomes not lower than the predetermined first value N1. This provides the same effect as that described in the previous paragraph.

Further, in the electronic control apparatus 30 according to the present embodiment, the backlash elimination period GT is the period from the time point at which the MG torque Tmg is not lower than the predetermined second value N2 and the change amount ΔNmg of the MG rotational speed Nmg per unit time Δt is not smaller than the predetermined third value N3, to the time point at which the change amount ΔNmg becomes not larger than the predetermined fourth value N4. As a result, the start and completion of the backlash elimination are directly detected, and even where the backlash elimination control GC and the damping control VC are used in combination, the occurrence of the rattling shock is suppressed with high accuracy.

### Second Embodiment

Next, another embodiment of the present invention will be described. It is noted that parts common to the above-described first embodiment will be given the same reference signs and descriptions thereof will be omitted.

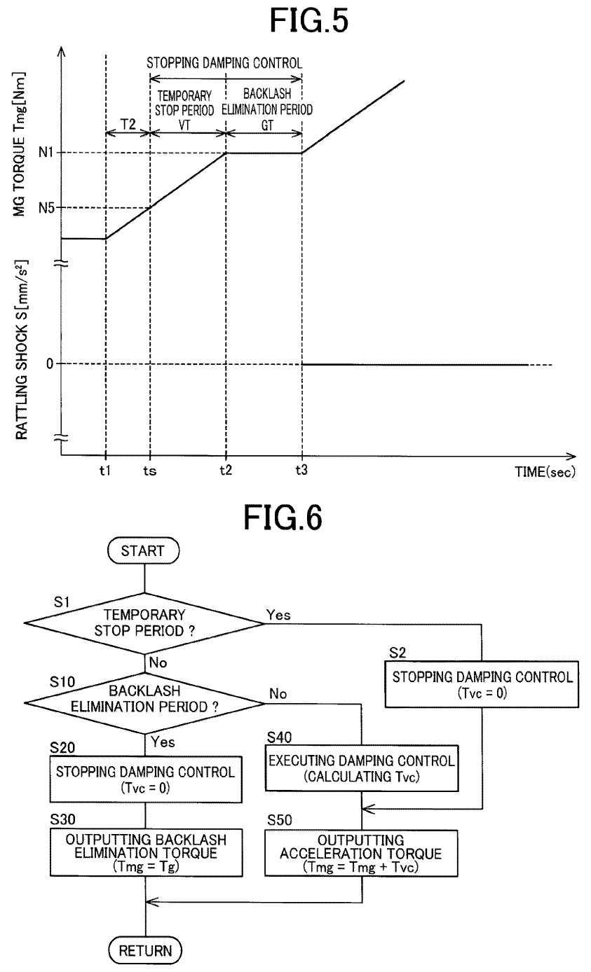

FIG. 5, which corresponds to FIG. 2 of the first embodiment, is a timing chart showing the control operation of the electronic control apparatus 30 in the second embodiment of the invention, which is performed when the vehicle 12 is switched from the non-driven state to the driven state.

In this second embodiment, as shown in FIG. 5, the electronic control apparatus 30 stops the execution of the damping control VC not only during the predetermined backlash elimination period GT but also a period from a time point a predetermined time before a start of the predetermined backlash elimination period GT, to the start of the predetermined backlash elimination period GT. Specifically, the electronic control apparatus 30 also stops the damping control VC from a temporary stop time point ts, which is a predetermined time before the backlash elimination period GT, to time point t2, which is the start time of the backlash elimination period GT. In FIG. 5, the period from the temporary stop time point ts to the time point t2 is designated as a temporary stop period VT, and the damping control VC is stopped during the temporary stop period VT and the backlash elimination period GT. The temporary stop time point ts is set, for example, before the backlash elimination period GT (at time point t2), to a time point at which a predetermined period T2 has elapsed from the time point 1 at which the increase of the MG torque Tmg begins, or to a time point at which the MG torque Tmg becomes not lower than a predetermined fifth value N5. The predetermined period T2 or the predetermined fifth value N5 is a set value determined in advance by design or experiment. By stopping the damping control VC from the temporary stop period VT, the damping control VC is stopped before the backlash-elimination control GC is executed, so that not only is there no interference during the execution of the backlash-elimination control GC, but influence of the damping control VC before the execution of the backlash-elimination control GC is also suppressed. Therefore, even where the backlash elimination control GC and the damping control VC are used together, the occurrence of the rattling shock is suppressed with high accuracy.

FIG. 6, which corresponds to FIG. 4 of the above-described first embodiment, is a flowchart explaining the main control operations of the electronic control apparatus 30, which are shown in the time chart of FIG. 5.

In a control routine shown in the flow chart of FIG. 6, steps S1 and S2 are added before S10 in the control routine show in FIG. 4 (of the first embodiment) to stop the damping control VC during the temporary stop period VT. This control routine is initiated with step S1 that is implemented to determine whether or not it is a temporary stop period VT. When a negative determination is made at step S1, the control flow goes to step S10 and the same process as in the control routine show in FIG. 4 (of the first embodiment) is executed. When an affirmative determination is made at step S1, step S2 is implemented to stop the damping control VC (damping torque Tvc=0), and then the control flow goes to step S50. At step S50, since the damping torque Tvc is 0, only the MG torque Tmg for accelerating the vehicle 12 is outputted, and this routine is returned.

As described above, in the electronic control apparatus 30 for the vehicle 12 according to this second embodiment, the execution of the damping control VC is stopped from the temporary stop time point ts, which is a predetermined time before the backlash elimination period GT, until the start of the backlash elimination period GT. Since the execution of the damping control VC is stopped also before the backlash elimination control GC is executed, not only is operational interference during the execution of the backlash elimination control GC suppressed, but the operational influence of the damping control VC before the execution of the backlash elimination control GC is also suppressed. Therefore, even where the backlash elimination control GC and the damping control VC are used together, the occurrence of rattling shock is suppressed with high accuracy.

Although the embodiments of the present invention have been described in detail above with reference to the drawings, the present invention can also be applied to other embodiments.

For example, in the above-described first and second embodiments, the vehicle 12 is an electric vehicle (BEV) powered by the electric motor 10, but the present invention can also be applied to a hybrid electric vehicle (HEV) powered by both an engine and an electric motor.

It should be noted that the above are merely embodiments, and the present invention can be embodied in various forms with various modifications and improvements based on the knowledge of those skilled in the art.

### Nomenclature of Elements

10: electric motor (power Source)
12: vehicle
14: power transmission device (gear-type power transmission device)
20: drive Wheel
30: electronic control apparatus
GC: backlash elimination control
GT: backlash elimination period
N1: predetermined first value
N2: predetermined second value
N3: predetermined third value
N4: predetermined fourth value
Nmg: MG rotational speed
T1: predetermined period
Tmg: MG torque (torque from power source)
ts: temporary stop time point
   (predetermined time point prior to the backlash elimination period)
Tvc: damping torque
VC: damping control
ΔNmg: change amount
Δt: unit time

What is claimed is:

1. A control apparatus for a vehicle including a drive wheel, a power source that includes an electric motor, and a gear-type power transmission device that is provided in a power transmission path between the power source and the drive wheel,
wherein the control apparatus is configured to execute a damping control for causing the electric motor to output a damping torque for suppressing vibrations in the vehicle,
wherein the control apparatus is configured, when switching the vehicle from a non-driven state to a driven state, to execute a backlash elimination control within a predetermined backlash elimination period, for stopping or slowly changing a torque of the power source,
and wherein the control apparatus is configured to stop execution of the damping control at least during execution of the backlash elimination control.

2. The control apparatus according to claim 1,
wherein the backlash elimination period is a predetermined period starting from a time point at which the torque of the power source becomes not lower than a predetermined first value.

3. The control apparatus according to claim 1,
wherein the backlash elimination period is a predetermined period from a point time at which the torque of the power source becomes not lower than a predetermined second value and an amount of change per unit time of a rotational speed of an output shaft of the power source becomes not smaller than a predetermined third value, to a point time at which the amount of change becomes not larger than a predetermined fourth value.

4. The control apparatus according to claim 1,
wherein the control apparatus is configured to stop the execution of the damping control not only during the predetermined backlash elimination period but also a period from a time point a predetermined time before a start of the predetermined backlash elimination period, to the start of the predetermined backlash elimination period.
